(19) United States
(12) Patent Application Publication
(10) Pub. No.: US 2008/0285880 A1
(43) Pub. Date: Nov. 20, 2008

(54) Method of Filtering Bending Features

(75) Inventors: Raoul Florent, Ville d'Avray (FR); Christophe Samson, Le Guevin (FR); Mathieu Picard, Sevres (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,768

(22) PCT Filed: Nov. 16, 2006
(86) PCT No.: PCT/IB2006/054298

§ 371 Date: May 15, 2008

(30) Foreign Application Priority Data
Nov. 18, 2005 (EP) 05300947.8

(51) Int. Cl. G06K 9/40

(52) U.S. Cl. 382/260

(57) ABSTRACT

The present invention relates to a method of filtering an input image using a target oriented filter pattern, which has been obtained by warping a source oriented filter pattern. Such a method comprises a step of computing a source oriented filter pattern at a central image point of said input image, said source oriented filter pattern comprising a source central line, a step of analyzing intensity levels of image points in the vicinity of the central image point for determining a target central line and a step of computing a target oriented filter pattern at the central image point from said target central line and said source oriented filter pattern by defining transformation rules between points of the source and points of the target oriented filter patterns. The method in accordance with the invention finally comprises a step of computing a target oriented filter from said target oriented filter pattern and of applying said target oriented filter to said input image for producing an output image.

### FIELD OF THE INVENTION

The present invention relates to a method of filtering an input image using a warped elongated filter. The present invention also relates to a system for filtering an input image, said system implementing said method. The present invention finally relates to a computer program for carrying out said method.

The present invention finds its application in the general domain of image processing for enhancing bending features and, in particular, in the domain of medical image processing for detecting a guide wire introduced in the body of a patient.

### BACKGROUND OF THE INVENTION

In medical image processing, it is often needed to enhance elongated features such as blood vessels, ribs or catheters. To this end, several techniques have been developed for designing oriented filters.

The document entitled “The design and use of steerable filters” by W. Freeman and E. Adelson, published in IEEE Transactions on Pattern Analysis and Machine Intelligence, Vol. 13(9), pp. 891-906, in 1991, discloses a class of filters which can be rotated in an efficient way with a minimal computational cost, given a linear combination of a suitable filter basis. Considering a two-dimensional (2D) image I comprising image points X comprising intensity levels, a steerable filter h in 2D is defined in the following way:

$$h ( x , y ) = {\sum }_{k = 1}^{M} {\sum }_{i = 0}^{k} {α}_{k , i} \frac{{\partial }^{k - i}}{\partial {x}^{k - i}} \frac{{\partial }^{i}}{\partial {y}^{i}} g ( x , y )$$

where g is an arbitrary isotropic window function, such as, for instance, a Gaussian function. The filter h is steerable in a direction θ, which means that the convolution of a function f of the image I with any rotated version of h can be expressed as the linear combination:

$$f ( X ) * h ( {R}_{θ} X ) = {\sum }_{k = 1}^{M} {\sum }_{i = 0}^{k} {b}_{k , i} ( θ ) {f}_{k , i} ( X ) ,$$

with X=(x,y), R_{θ} a rotation matrix and b_{k,I} orientation-dependent weights.
Functions f_{k,i} are filtered versions of f such that:

$${f}_{k , i} ( x , y ) = f ( x , y ) * ( \frac{{\partial }^{k - i}}{\partial {x}^{k - i}} \frac{{\partial }^{i}}{\partial {y}^{i}} g ( x , y ) )$$

and where the orientation-dependant weights b_{k,i} are trigonometric polynomials defined by:

$${b}_{k , i} ( θ ) = ( {\sum }_{j = 0}^{k} {α}_{k , j} {\sum }_{l , m ∈ S ( k , i , j )} ( \begin{matrix}k - j \\ l\end{matrix} ) ( \begin{matrix}j \\ m\end{matrix} ) {( - 1 )}^{m} {cos ( θ )}^{j + ( l - m )} {sin ( θ )}^{( k - j ) - ( l - m )} )$$

with the set S(k,i,j)={l,m/0≦l≦k−i; 0≦m≦i; k−(l+m)=j}.
Once the f_{k,i} are determined, the convolution off with h (R_{θ}X) can be evaluated in an efficient way through a linear sum of weighted terms.

A drawback of the approach presented above is that the direction is the single characteristic of the intensity levels of the image which has been taken into account. This implicitly assumes that these oriented filters have been designed on the basis of an axially symmetric or anti-symmetric model. Whereas this assumption is most often asymptotically valid on a continuous signal, this is usually not the case when considering a discrete image, in particular at a small scale when features of small sizes are searched. When the axial-symmetry assumption is false, blurring and sub-optimal filtering inevitably occurs. In particular, steerable filters are not adapted to detect bending features, which are often present in medical images, such as a guide wire.

### SUMMARY OF THE INVENTION

It is an object of the invention to propose a method and system for filtering bending features in an input image which is more efficient.

This is achieved by a method of filtering an input image comprising image points comprising intensity levels, said method comprising the steps of:
computing a source oriented filter pattern at a central image point of said input image, said source oriented filter pattern comprising a source central line;
analyzing intensity levels of image points in a vicinity of the central image point for determining a target central line;
computing a target oriented filter pattern at the central image point, said step comprising the sub-steps of:
   computing a correspondence rule between a source point belonging to the source oriented filter pattern and a corresponding source line point of the source central line;
   computing a warping rule for warping the corresponding source line point of the source central line on to a corresponding target line point of the target central line;
   computing an inverse correspondence rule between the corresponding target line point of the target central line and a target point of the target oriented filter pattern.
computing a target oriented filter from said target oriented filter pattern;
applying said target oriented filter to said input image for producing an output image.

With the invention, a source oriented filter pattern is computed at a central image point. An analysis of intensity levels in the vicinity of the central image point is intended to determine parameters of a target central line. Therefore, such a target central line is defined in relation to features present in the image, in particular bending elongated features. The defined target central line is then used to warp the source oriented filter pattern. This is achieved by computing transformation rules in the following way:
1 a correspondence rule between a source point belonging to the source oriented filter pattern and a corresponding source line point of the source central line;
2. a warping rule between the corresponding source line point and a corresponding target line point of the target central line;
3. an inverse correspondence rule between the corresponding target line point and a target point of the target oriented filter pattern.

In this way, the locations of the target points belonging to the target oriented filter pattern are computed by applying the above defined transformation rules to the points belonging to the source oriented filter pattern. Therefore a curved oriented filter pattern is obtained, which results from bending an oriented filter pattern on the basis of the analysis of intensity levels in the vicinity of the central image point. A target oriented filter is finally derived from the target oriented filter pattern using techniques well-known to the skilled person.

The target oriented filter pattern produced has a curved shape which has been designed on the basis of an analysis of the input image and which is, therefore, perfectly adapted to the image intensity level variation. Consequently, the target oriented filter is more efficient on the input image for enhancing features present in the input image than a straight elongated oriented filter.

In a first embodiment of the invention, the analysis step is intended to estimate a curvature radius vector at the central image point, said curvature radius vector having a curvature radius modulus and a curvature orientation, which define an r-radius circle having a radius equal to said curvature radius modulus and a center located at the central image point expressed by the curvature vector and wherein the target central line is a sector of said r-radius circle, said sector having a sector angle. An advantage of the first embodiment of the invention is that the warping rule for warping the corresponding source line point of the source central line on to a corresponding target line point of the target central line is very simple.

With the invention, the transformation rules can be defined in various ways. In the following, it is considered that the source oriented filter pattern is oriented in a filtering direction and comprises a local spatial coordinate reference frame, which is centered on the central image point and has a spatial coordinate corresponding to a first axis oriented in the filtering direction and a second spatial coordinate which is perpendicular to said first axis.

In a second embodiment of the invention, the correspondence rule is defined in such a way that the corresponding source line point has the same first spatial coordinate as the source point. Therefore, a location of the corresponding source line point is easy to calculate.

Advantageously, the warping rule is defined in such a way that the corresponding target line point has the same first spatial coordinate as the source line point. Therefore, a location of the corresponding target line point is easy to calculate.

Advantageously, the inverse correspondence rule is defined in such a way that the target point and the corresponding target line point of the target central line have the same first spatial coordinate and that a vector linking the target point to the corresponding target line point is the same as a vector linking the source point to the corresponding target line point. Therefore, a location of the corresponding target point is easy to calculate.

In a third embodiment of the invention, the correspondence rule is defined as an orthogonal projection of the source point on to the source central line.

Advantageously, the inverse correspondence rule is defined as an orthogonal projection of the target point on to the target central line. In addition, the inverse correspondence rule specifies that a vector linking the target point to the corresponding target line point is the same as a vector linking the source point to the corresponding target line point.

An advantage is that these correspondence and inverse correspondence rules amount to a local rigid transformation. This means that the segment line between the corresponding source line point and the source point is perpendicular to a tangent of the source central line and that the segment line between the corresponding target line point and the target point is perpendicular to a tangent of the target central line.

Advantageously, the warping rule is defined in such a way that an arclength between the central point and the source line point is equal to an arclength between the central image point and the target line point. An advantage is that there is no longitudinal distortion of the target oriented filter pattern with respect to the source oriented filter pattern.

In an alternative, the warping rule is defined in such a way that a distance between the central image point and the source line point is equal to a distance between the central image point and the target line point. An advantage is that this method introduces only a small amount of longitudinal distortion of the target oriented filter pattern while being easy to implement.

The invention also relates to an image processing system for filtering an image comprising image points, said system using said method.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 schematically describes the method in accordance with the invention;

FIG. 2 is a schematic drawing of a source oriented filter pattern centered on a central image point;

FIG. 3 schematically describes the transformation rules used for transforming the source oriented filter pattern into a target oriented filter pattern in accordance with the invention;

FIG. 4A is a schematic drawing of a determination of the target central line in accordance with a first embodiment of the invention;

FIG. 4B schematically illustrates a definition of the correspondence and inverse correspondence rules in accordance with a second embodiment of the invention;

FIGS. 5A and 5B are schematic drawings of both definitions of the warping rule in accordance with a second embodiment of the invention;

FIG. 6A is a schematic drawing of a definition of the warping rule in accordance with a third embodiment of the invention;

FIG. 6B is a schematic drawing of a definition of the correspondence rule in accordance with a third embodiment of the invention;

FIG. 7 is a schematic drawing of a system in accordance with the invention.

### DETAILED DESCRIPTION OF THE INVENTION

The invention relates to a method of filtering an input image for producing an output image. In the following, an image is considered as a 2D array of image points, an image point comprising an intensity level and being located in the 2D array by spatial coordinates of a reference frame of the image. It should be noted however that 3D arrays of image points are also within the scope of the invention.

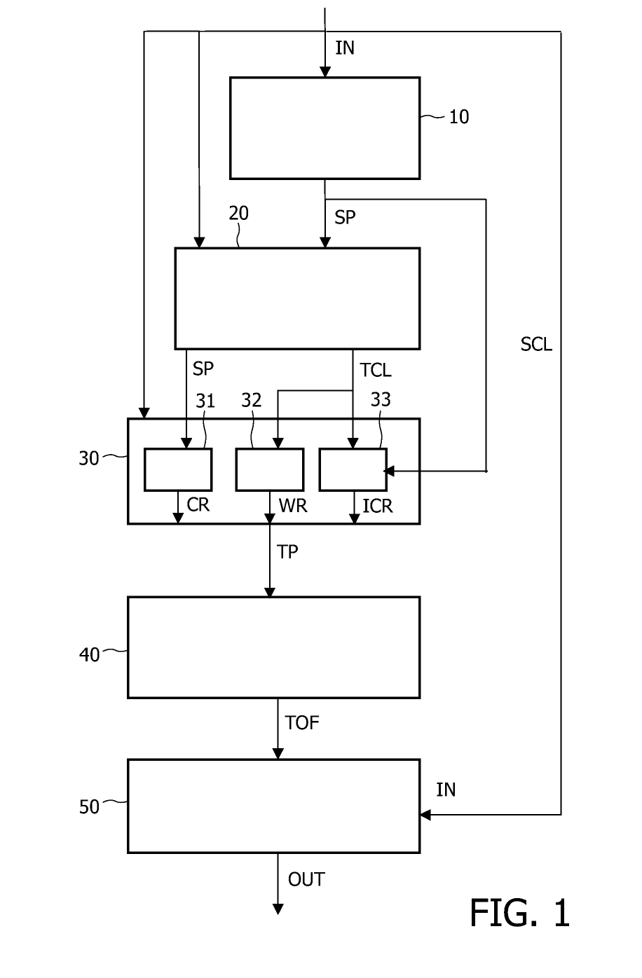

Referring to FIG. 1, such a method comprises a step 10 of computing a source oriented filter pattern SP at a central image point P₀ of an input image IN, said source oriented filter pattern comprising a source central line SCL.

In the following, a filter pattern stands for a function representing an ideal kernel of a filter. This function can be parametrically defined or it can be defined in extension, that is every value for every spatial coordinate of the filter kernel. This function is defined on a set of special points.

It should be noted that, for simplicity reasons, the source central line SCL represented in FIG. 1 is a straight line, but that the source oriented filter pattern SP may also have a curved source central line. In this case, the curved source central line is expected to be a regular curve, which can be derived.

The method in accordance with the invention further comprises a step 20 of analyzing intensity levels IL of image points in the vicinity V of the central image point P₀ for determining a target central line TCL and a step 30 of computing a target oriented filter pattern TP at the central image point P₀ from said target central line TCL. Said step 30 comprises the sub-steps of:
computing 31 a correspondence rule CR between a source point P2 belonging to the source oriented filter pattern and a corresponding source line point P1 of the source central line;
computing 32 a warping rule WR for warping the corresponding source line point P₁ of the source central line on to a corresponding target line point P′1 of the target central line;
computing 33 an inverse correspondence rule ICR between the corresponding target line point P′₁ of the target central line and a target point P′₂ of the target oriented filter pattern.

The method in accordance with the invention finally comprises a step 40 of computing a target oriented filter TOF from said target oriented filter pattern TP and a step 50 of applying said target oriented filter TOF to said input image IN for producing an output image OUT.

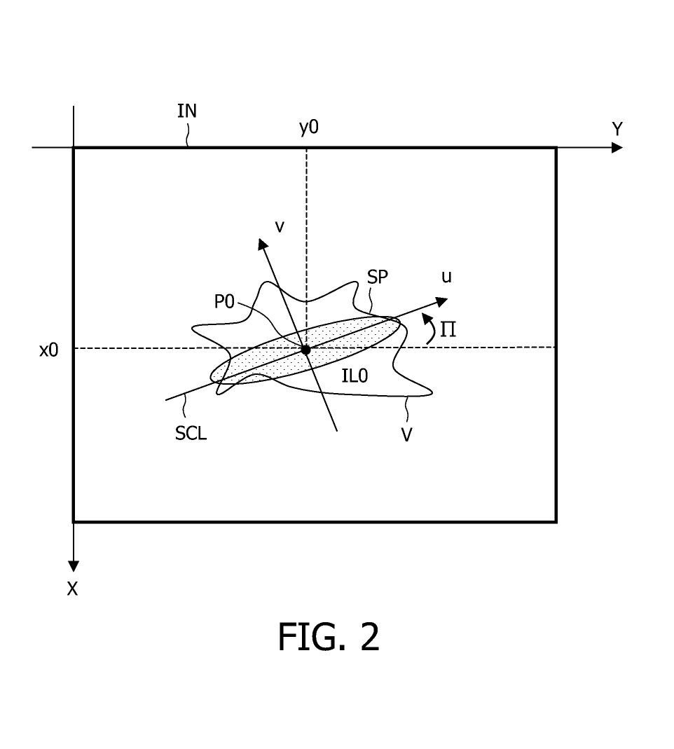

Referring to FIG. 2, the central image point P₀ comprises an intensity level IL₀ with which there are associated spatial coordinates (x₀,y₀) in a reference frame (O,x,y) of the input image. With the invention, the source oriented filter pattern SP is centered on the central image point P₀ and oriented in a filtering direction θ. In the following a local reference frame (u, v) centered on the central image point P₀ and oriented in the filtering direction θ is considered. Thus, the source central line SCL of the source oriented filter pattern SP is oriented in the direction u.

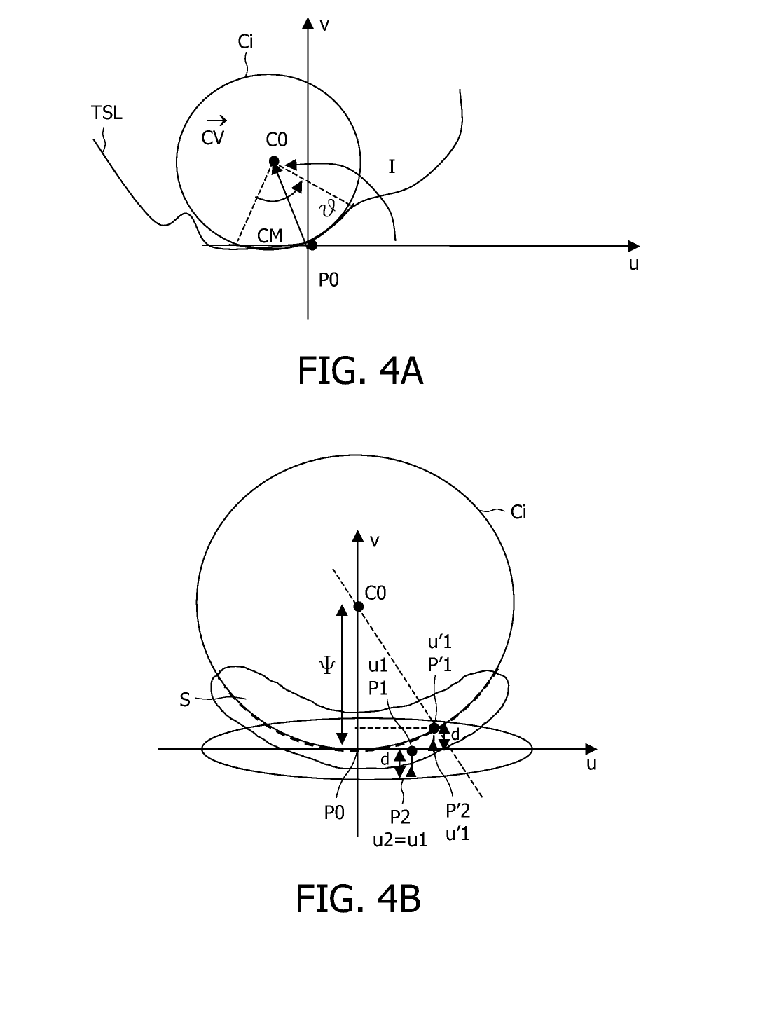

It should be noted that the target central line does not necessarily have an orientation at the central image point P₀ which is equal to the filtering direction θ. Therefore, the method in accordance with the invention advantageously comprises a step of calculating an orientation φ of the target central line at the central image point and a step of rotating the local reference frame (u,v) into a rotated reference frame (u₀,v₀) as shown in FIG. 4A. In the following, for simplicity reasons, only the local reference frame (u,v) will be considered.

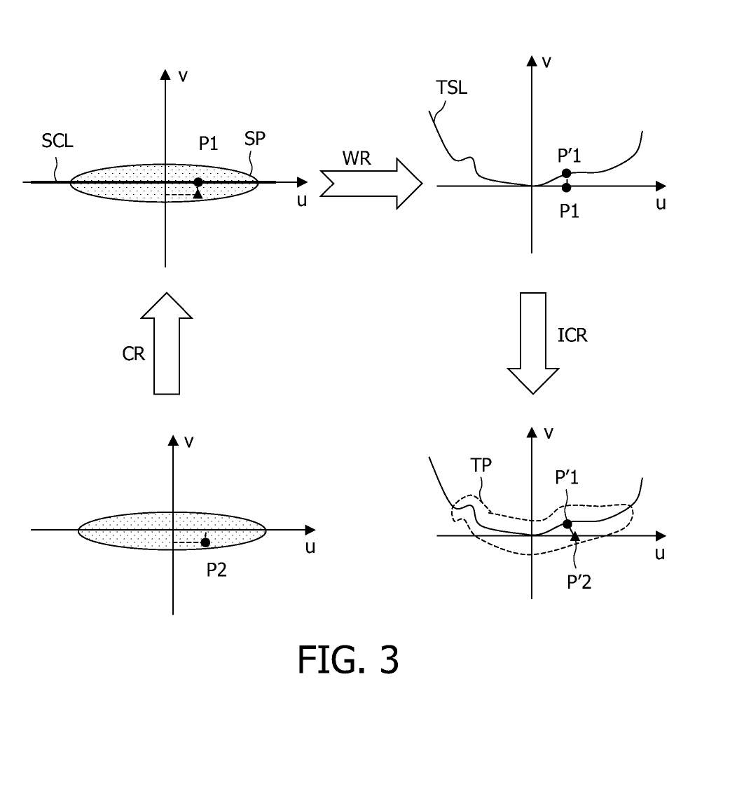

Referring to FIG. 3, a source point P₂ located within the source oriented filter pattern SP centered on the image point P₀ is considered. For simplicity reasons, the filtering direction θ has been chosen equal to zero, but any value of θ is within the scope of the present invention. With the invention, the step 30 of computing a target oriented filter pattern TP at the central image point P₀ from the target central line TCL is intended to calculate a location of a corresponding target point P′₂ in the target oriented filter pattern TP. To this end, three transformation rules are calculated for transforming the source point P₂ into the target point P′₂ in three sub-steps:
1. A corresponding source line point P₁ belonging to the source central line SCL is considered. A corresponding rule CR is defined by the sub-step 31 for locating the corresponding source line point P₁ from a location of the source point P₂;
2. A warping rule WR is computed by the sub-step 32 for transforming the corresponding source line point P₁ into a corresponding target line point P′₁ belonging to the target central line;
3. An inverse corresponding rule ICR is finally defined for transforming the corresponding target line point P′₁ into the target point P′₂.
   With the invention, the step 20 of analyzing intensity levels IL of image points in the vicinity V of the central image point P₀ involves image processing techniques which are well-known to the skilled person. For instance, a gradient operator may be applied to the image for determining a direction of elongated features present in the image. In addition, local parameters for characterizing a shape of the elongated features in more detail may be calculated as known in the art.

Referring to FIG. 4A and in accordance with a first embodiment of the invention, the analysis step is intended to estimate a curvature radius vector \vec{CV} at the central image point P₀. The curvature radius vector \vec{CV} has a curvature radius modulus CM and a curvature orientation α, which define an r-radius circle Ci having a radius ρ equal to said curvature radius modulus CM and a center C located at the central image point P₀ expressed by the curvature vector \vec{CV}. In this case, the target central line TCL is locally determined as a sector S of the r-radius circle Ci. Said sector S is, for instance, characterized by a sector angle β. An advantage of the first embodiment is that the target central line is easy to calculate. Moreover, the filter is very adapted to signal bending, since the curvature radius vector is the most natural way of estimating the bending of a signal.

It should be noted that, with the invention, the transformation rules, which are the correspondence rule, the warping rule and the inverse correspondence rule, can be defined in various ways.

Referring to FIG. 4B and in accordance with a second embodiment of the invention, the correspondence rule CR is defined in such a way that, for a source point P₂, the corresponding source line point P₁ belonging to the source central line has the same first spatial coordinate u₂ as the source point P₂. Therefore, a location of the corresponding source line point P₂ is easy to calculate.

Advantageously, the inverse correspondence rule ICR is defined in such a way that the target point P′₂ and the corresponding target line point P′₁ of the target central line have the same first spatial coordinate u′₂=u′₁ and that a vector \vec{P′₂P′₁} linking the target point P′₂ and the corresponding target line point P′₁ is the same as a vector \vec{P₂P₁} linking the source point P₂ to the corresponding target line point P₁. Therefore, a location of the corresponding target point P′₂ is easy to calculate.

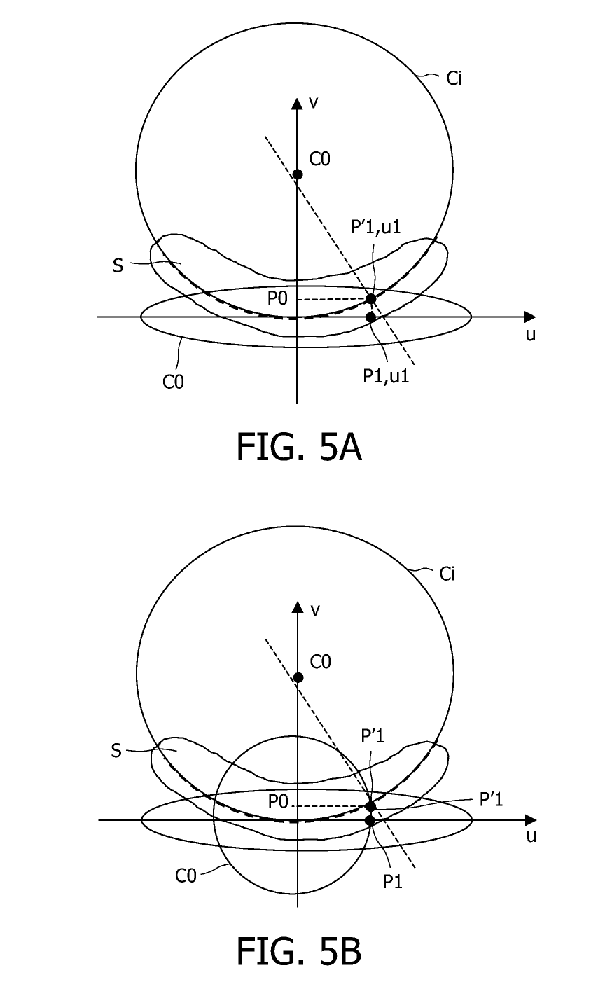

Referring to FIG. 5A, the warping rule is advantageously defined in such a way that the corresponding target line point P′₁ has the same first spatial coordinate u′₁=u₁ as the source line point P₁. Therefore, a location of the corresponding target line point is easy to calculate.

In a first alternative shown in FIG. 5B, the warping rule WR is advantageously defined in such a way that a distance between the central image point P₀ and the source line point P₁ is equal to a distance between the central image point P₀ and the target line point P′₁. In other words, the source line point and the target line point are both comprised on a circle C₀ centered on the central image point P₀. An advantage is that the length of the source oriented filter pattern SP is saved by the warping transformation into the target oriented filter pattern TP.

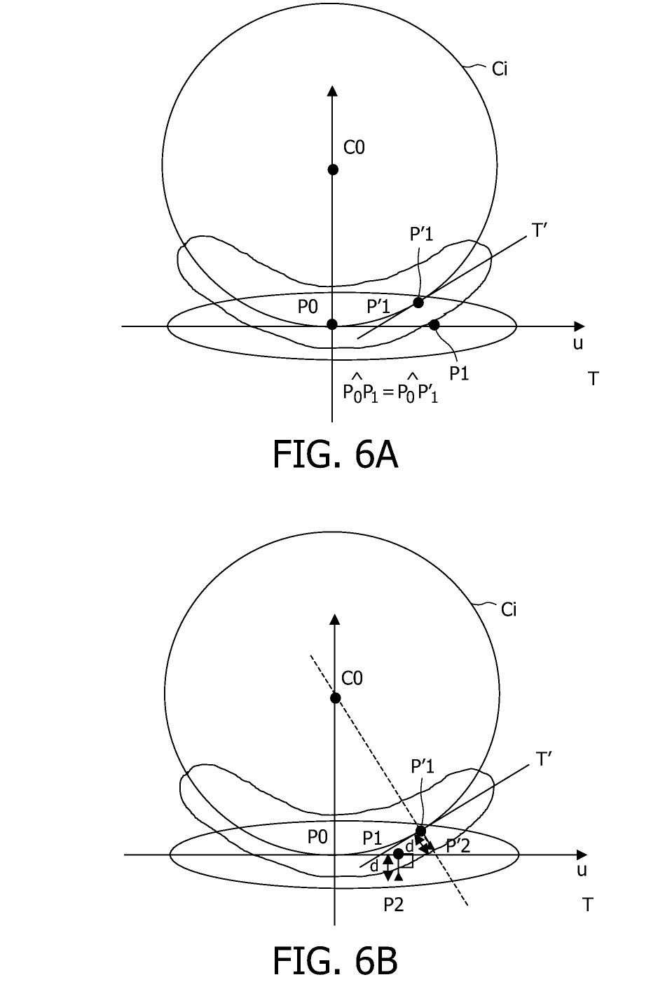

In a second alternative shown in FIG. 6A, the warping rule WR is advantageously defined in such a way that an arclength between the central image point P₀ and the source line point P₁ is equal to an arclength between the central image point P₀ and the target line point P′₁.

Referring to FIG. 6B and in accordance with a third embodiment of the invention, the correspondence rule CR is defined as an orthogonal projection of the source point P₂ on to the source central line SCL. In other words, a segment line P₂P₁ between the corresponding source line point P₁ and the source point P₂ is perpendicular to a tangent T of the source central line SCL.

Advantageously, the inverse correspondence rule is defined as an orthogonal projection of the target point P′₂ on to the target central line. In addition, the inverse correspondence rule also specifies that a vector \vec{P′₂P′₁} linking the target point P′₂ to the corresponding target line point P′₁ is the same as a vector \vec{P₂P₁} linking the source point P₂ to the corresponding target line point P₁.

Therefore, a local rigid transformation is applied with no lateral distortion.

Advantageously, the step 20 of analyzing intensity levels IL of image points in the vicinity V of the central image point P₀ may determine other parameters of the bending feature present in the vicinity, such as a width of this bending feature. These parameters may further be used for computing the transformation rules to apply to the source oriented filter pattern. For instance, for the warping rule WR, the width may be used for computing a scale factor for multiplying an arclength between the central image point P₀ and the source line point P₁ in order to calculate an arclength between the central image point P₀ and the target line point P′₁.

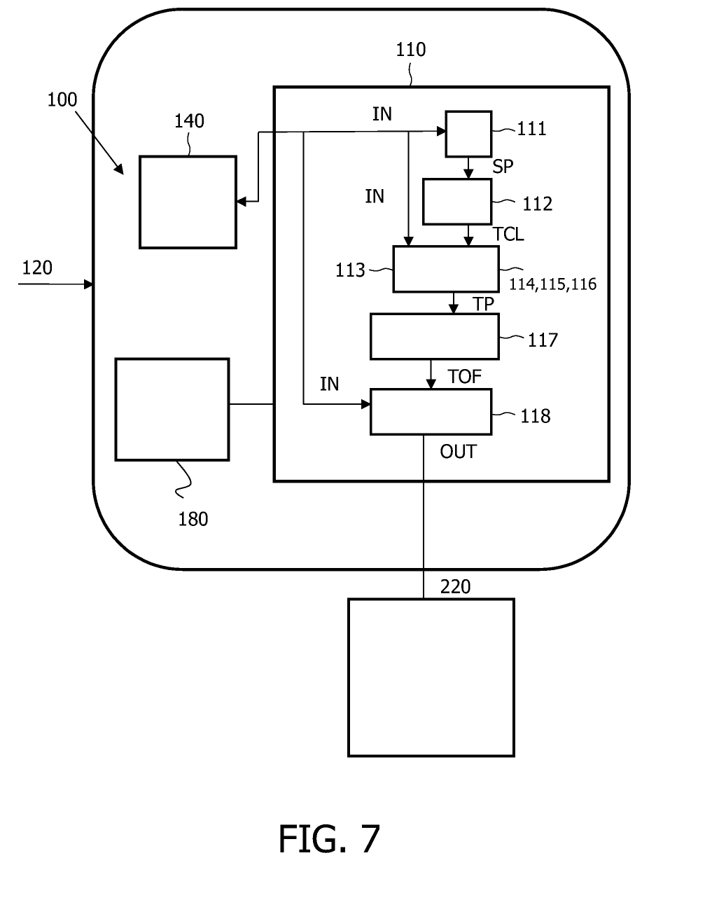

Referring to FIG. 7, a computer system including a system 110 for filtering an input image and producing an output image in accordance with the invention is presented. The computer system 100 includes an image data signal input 120 and a memory 140 for storing image data input into the system through the input 120. The system 110 includes a processor that is programmed to control input image data processing in accordance with the present invention, along with a system power source 180. The computer system also includes a video monitor 200 which receives the processed output image from the processor via the output 220. The method for filtering an input image IN in accordance with the invention may be programmed by a computer program through a conventional programming language in the memory 140 and utilized by the system 110. Alternatively the system 110 may be implemented by hardware.

The system 110 in accordance with the invention comprises:
means 111 for computing a source oriented filter pattern SP at a central image point P₀ of the input image IN, said source oriented filter pattern SP comprising a source central line SCL;
means 112 for analyzing intensity levels IL of image points in the vicinity V of the central image point P₀ for determining a target central line TCL;
computing 113 a target oriented filter pattern at the central image point, said step comprising the sub-steps of:
   computing 114 a correspondence rule between a source point belonging to the source oriented filter pattern and a corresponding source line point of the source central line;
   computing 115 a warping rule for warping the corresponding source line point of the source central line on to a corresponding target line point of the target central line;
   computing 116 an inverse correspondence rule between the corresponding target point of the target central line and a target point of the warped oriented pattern.
computing 117 a target oriented filter from said target oriented filter pattern; and
applying 118 said target oriented filter to said input image for producing an output image.

The drawings and their description hereinbefore illustrate rather than limit the invention. It will be evident that there are numerous alternatives, which fall within the scope of the appended claims. In this respect the following closing remarks are made: there are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions, nor does it exclude that a single function is carried out by an assembly of items of hardware or software, or both.

Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

1. A method of filtering an input image comprising image points, said method comprising the steps of:
computing a source oriented filter pattern at a central image point of said input image, said source oriented filter pattern comprising a source central line;
analyzing intensity levels of image points in a vicinity of the central image point for determining a target central line;
computing a target oriented filter pattern at the central image point, said step comprising the sub-steps of:
computing a correspondence rule between a source point belonging to the source oriented filter pattern and a corresponding source line point of the source central line;
computing a warping rule for warping the corresponding source line point of the source central line on to a corresponding target line point of the target central line;
computing an inverse correspondence rule between the corresponding target line point of the target central line and a target point of the warped oriented pattern.
computing a target oriented filter from said target oriented filter pattern; and
applying said target oriented filter to said input image for producing an output image.

2. The method of filtering an input image of claim 1, wherein the source oriented filter pattern is oriented in a filtering direction and comprises a local spatial coordinate reference frame, which is centered on the central image point and has a spatial coordinate corresponding to a first axis oriented in the filtering direction and a second spatial coordinate which is perpendicular to said first axis.

3. The method of filtering an input image of claim 1, wherein the analysis step is intended to estimate a curvature radius vector at the central image point, said curvature radius vector having a curvature radius modulus and a curvature orientation, which define an r-radius circle having a radius equal to said curvature radius modulus and a center located at the central image point expressed by the curvature vector and wherein the target central line is a sector of said r-radius circle, said sector having a sector angle.

4. The method of filtering an input image in accordance with claim 2, wherein the correspondence rule is defined in such a way that the corresponding source line point has the same first spatial coordinate as the source point.

5. The method of filtering an input image of claim 2, wherein the warping rule is defined in such a way that the corresponding target line point has the same first spatial coordinate as the source line point.

6. The method of filtering an input image of claim 2, wherein the inverse correspondence rule is defined in such a way that the target point and the corresponding target line point of the target central line have the same first spatial coordinate and that a vector linking the target point to the corresponding target line point is the same as a vector linking the source point to the corresponding target line point.

7. The method of filtering an input image in accordance with claim 2, wherein the correspondence rule is an orthogonal projection of the source point on to the source central line.

8. The method of filtering an input image of claim 2, wherein the warping rule is defined in such a way that a distance between the central image point and the source line point is equal to a distance between the central image point and the target line point.

9. The method of filtering an input image of claim 2, wherein the warping rule is defined in such a way that an arclength between the central image point and the source line point is equal to an arclength between the central image point and the target line point.

10. The method of filtering an input image of claim 2, wherein the inverse correspondence rule is defined as an orthogonal projection of the target point on to the target central line and in such a way that a vector linking the target point to the corresponding target line point is the same as a vector linking the source point to the corresponding target line point.

11. A system for filtering an input image comprising image points, said system comprising:
means for computing a source oriented filter pattern at a central image point of said input image, said source oriented filter pattern comprising a source central line;
means for analyzing intensity levels of image points in a vicinity of the central image point for determining a target central line;
means for computing a target oriented filter pattern at the central image point, said means comprising:
sub-means for computing a correspondence rule between a source point belonging to the source oriented filter pattern and a corresponding source line point of the source central line;
sub-means for computing a warping rule for warping the corresponding source line point of the source central line on to a corresponding target line point of the target central line;
sub-means for computing an inverse correspondence rule between the corresponding target point of the target central line and a target point of the target oriented pattern.
means for computing a target oriented filter from said target oriented pattern; and
means for applying said target oriented filter to said input image for producing an output image.

12. A computer program product for a computer, comprising a set of instructions, which, when loaded into said computer, causes the computer to carry out the method as claimed in claim 1.
